(19) United States
(12) Patent Application Publication
(10) Pub. No.: US 2026/0316678 A1
(43) Pub. Date: Oct. 15, 2026

(54) DISPLAY CONTROL METHOD AND APPARATUS FOR VEHICLE, ELECTRONIC DEVICE AND STORAGE MEDIUM

(71) Applicant: SANECHIPS TECHNOLOGY CO., LTD., Shenzhen (CN)

(72) Inventor: Chenming ZHANG, Shenzhen, Guangdong (CN)

(21) Appl. No.: 19/483,430

(22) PCT Filed: May 31, 2024
(86) PCT No.: PCT/CN2024/096637

§ 371 Date: Nov. 11, 2025

(30) Foreign Application Priority Data
Jun. 1, 2023 (CN) 202310645371.4

(51) Int. Cl. B60R 1/22; B60Q 9/00; G06V 10/25; G06V 20/56

(52) U.S. Cl. CPC B60R 1/22; B60Q 9/00; G06V 10/25; G06V 20/56; B60R 2300/80

(57) ABSTRACT

A method of controlling a display device of a vehicle includes: obtaining information related to driving of the vehicle; determining an area of interest around the vehicle based on the information related to driving of the vehicle; determining an image capturing device capable of capturing an image of the area of interest; and controlling the display device to display the image captured by the determined image capturing device.

### CROSS REFERENCE TO RELATED APPLICATIONS

The present disclosure is a National Phase Application filed under 35 U.S.C. 371 as a national stage of PCT/CN2024/096637, filed on May 31, 2024, and claims the priority to Chinese Patent Application No. 202310645371.4 entitled “DISPLAY CONTROL METHOD AND APPARATUS FOR VEHICLE, ELECTRONIC DEVICE AND STORAGE MEDIUM” and filed on Jun. 1, 2023, the contents of which are incorporated herein by reference in their entirety.

### TECHNICAL FIELD

The present disclosure relates to the technical field of intelligent transportation, and particularly relates to a display control method and apparatus for a vehicle, an electronic device and a storage medium.

### BACKGROUND

Current vehicles, such as passenger cars, are typically provided with a plurality of cameras, including a front camera, a rear camera, a left blind area camera, a right blind area camera and the like, and a display screen is provided at a position of a conventional rearview mirror or at a front position of a driver to display images captured by the cameras mounted on the vehicles.

### SUMMARY

The present disclosure provides display control method and apparatus for a vehicle, a device and a storage medium.

A first aspect of the present disclosure provides a display control method for a vehicle having a display device, the method includes: obtaining information related to driving of the vehicle; determining an area of interest around the vehicle based on the information related to driving of the vehicle; determining an image capturing device capable of capturing an image of the area of interest; and controlling the display device to display the image captured by the determined image capturing device.

A second aspect of the present disclosure provides a display control apparatus for a vehicle having a display device, including: an obtaining module configured to obtain information related to driving of the vehicle; an area determination module configured to determine an area of interest around the vehicle based on the information related to driving of the vehicle; a device determination module configured to determine an image capturing device capable of capturing an image of the area of interest; and a display module configured to control the display device to display the image captured by the determined image capturing device.

A third aspect of the present disclosure provides an electronic device, including: at least one processor; and a memory having one or more programs stored thereon which, when executed by the one or more processors, cause the one or more processors to implement the method in the first aspect; and at least one I/O interface connected between the processor and the memory and configured to enable information interaction between the processor and the memory.

A fourth aspect of the present disclosure provides a computer-readable medium storing a computer program thereon which, when executed by a processor, causes the method in the first aspect to be implemented.

### BRIEF DESCRIPTION OF DRAWINGS

FIG. 1 is a schematic flowchart of a display control method for a vehicle according to an embodiment of the present disclosure;

FIG. 2 is a schematic flowchart of a display control method for a vehicle equipped with a plurality of image capturing devices according to an embodiment of the present disclosure;

FIG. 3 is a schematic scenario diagram of detecting road condition information by an automotive radar according to an embodiment of the present disclosure;

FIG. 4a is a schematic structural diagram of selecting a camera image using information detected by an automotive radar according to an embodiment of the present disclosure;

FIG. 4b is a schematic flowchart of intelligently selecting a camera image using information detected by an automotive radar according to an embodiment of the present disclosure;

FIG. 5 is a schematic scenario diagram of obtaining road condition information by V2X according to an embodiment of the present disclosure;

FIG. 6a is a schematic structural diagram of intelligently selecting a camera image using V2X information according to an embodiment of the present disclosure;

FIG. 6b is a schematic flowchart of intelligently selecting a camera image using V2X information according to an embodiment of the present disclosure;

FIG. 7 is a schematic diagram of a control logic of intelligently selecting a camera image according to an embodiment of the present disclosure;

FIG. 8 is a schematic structural diagram of a display control apparatus for a vehicle according to an embodiment of the present disclosure; and

FIG. 9 is a schematic structural diagram of an electronic device according to an embodiment of the present disclosure.

### DETAIL DESCRIPTION OF EMBODIMENTS

Hereinafter, specific implementations of the present disclosure will be described in detail with respect to the accompanying drawings. It will be appreciated that the specific implementations described herein are merely for illustration and explanation of the present disclosure and are not intended to limit the present disclosure.

As used in the present disclosure, the term “and/or” includes any and all combinations of one or more of the associated listed items.

The terms used herein are only intended to describe specific embodiments and are not intended to limit the present disclosure. As used in the present disclosure, the singular forms “a”, “an” and “the” are intended to include the plural forms as well, unless the context clearly indicates otherwise.

When used herein, the terms “include”, “comprise” and/or “consist of” specify the presence of the stated features, integers, steps, operations, elements, and/or components, but do not preclude the presence or addition of one or more other features, integers, steps, operations, elements, components, and/or groups thereof.

Unless otherwise defined, all terms (including technical and scientific terms) used in the present disclosure have the same meaning as commonly understood by one of ordinary skill in the art. It will be further understood that terms, such as those defined in commonly used dictionaries, should be interpreted as having a meaning that is consistent with their meaning in the context of the existing art and the present disclosure, and will not be interpreted in an idealized or overly formal sense unless expressly so defined in the present disclosure.

An existing mode of selecting an image from images captured by a plurality of cameras for display is not intelligent enough, and default display of an image from a front camera during vehicle driving cannot meet viewing requirements of a user during vehicle driving.

To solve a problem that a single and monotonous display switching method of a display device on a vehicle cannot meet requirements of a user during driving, the embodiments of the present disclosure provide a display control method for a vehicle, including a passenger car, a bus, a coach, a ship and the like. The display control method may be performed by a processing device mounted on the vehicle, which can obtain images of peripheral areas of the vehicle and control a display device to display the images, and can obtain information related to driving of the vehicle (e.g., left turn, right turn, driving speed, merging to left lane, merging to right lane, and the like). The specific implementation form of the processing device is not limited as long as it has a software program processing capability. For example, the processing device may be specifically a central processing unit, a central control computer, a central control chip, or the like.

FIG. 1 is a schematic flowchart of a display control method for a vehicle according to an embodiment of the present disclosure. The vehicle has a display device, and the method mainly includes the following operations 101 to 104.

In operation 101, information related to driving of the vehicle is obtained.

In some embodiments, obtaining the information related to driving of the vehicle includes at least one of: obtaining information of a surrounding object of the vehicle; obtaining driving operation information of the vehicle; or obtaining driving data information of the vehicle.

In some embodiments, obtaining the information of the surrounding object of the vehicle includes at least one of: obtaining the information of the surrounding object of the vehicle by a radar device; obtaining information of another vehicle around the vehicle through vehicle to X (V2X) communication with the other vehicle; or obtaining the information of the surrounding object of the vehicle by an image capturing device. The image capturing device may refer to an image capturing device on another equipment or an image capturing device mounted on the vehicle itself. It should be noted that these obtaining methods are only exemplary here, and other methods of obtaining the information of surrounding object of the vehicle are also included herein, for example, obtaining the information of the surrounding object of the vehicle by the Internet of Things.

In some embodiments, obtaining the driving operation information of the vehicle includes: obtaining information indicating that a driving direction of the vehicle is changing or is about to change, for example, information indicating that the vehicle is merging to left lane, merging to right lane, turning to left, turning to right, travelling straight, reversing, and the like. It should be noted that the obtaining method is only exemplary here, and other methods of obtaining the driving operation information of the vehicle are also included herein.

In some embodiments, the driving data information of the vehicle may be obtained in various manners. For example, road condition information of the vehicle, including traffic light status, road maintenance information, road jam conditions, and the like, can be obtained through the Internet of Things.

In operation 102, an area of interest around the vehicle is determined based on the information related to driving of the vehicle.

In some embodiments, determining the area of interest around the vehicle based on the information related to driving of the vehicle includes at least one of: determining an area in which there is an object having a distance to the vehicle smaller than a preset threshold as the area of interest based on the information of the surrounding object of the vehicle; determining an area pointed by a driving direction or a driving direction to be switched of the vehicle as the area of interest based on the driving operation information of the vehicle; determining a real-time driving blind area (i.e., an area which cannot be observed by a driver through sights, including areas which cannot be observed through a middle rearview mirror and a side rearview mirror) of the vehicle as the area of interest based on the driving data information of the vehicle; determining an area pointed by a driving direction when a real-time physical speed of the vehicle exceeds a preset threshold as the area of interest based on the driving data information of the vehicle; or determining an area in which there is an object approaching the vehicle at a relative speed beyond a threshold as the area of interest based on the information of the surrounding object of the vehicle.

It should be noted that these areas are only exemplary here, and other areas with possible driving dangers, poor road conditions such as an obstacle, and the like, may also be determined as the area of interest.

In some embodiments, obtaining the information indicating that the driving direction of the vehicle is about to change includes: obtaining turn signal information of the vehicle. It should be noted that the information is only exemplary here, and other information that can predict a change in the driving direction is also included. For example, when the vehicle is in a lane for left turn, right turn, U-turn, or the like, it can also be predicted that the driving direction of the vehicle is about to change.

In some embodiments, determining the area pointed by the driving direction or the driving direction to be switched of the vehicle as the area of interest based on the driving operation information of the vehicle includes at least one of: determining an area pointed by a merging direction of the vehicle as the area of interest based on the driving operation information of the vehicle; or determining an area where a direction indicated by a turn signal of the vehicle is located as the area of interest based on the driving operation information of the vehicle.

For example, a left area of the vehicle, which is pointed by the vehicle when merging to a left lane, is determined as the area of interest; a right area of the vehicle, which is pointed by the vehicle when merging to a right lane, is determined as the area of interest; a left area, where a direction indicated by a left turn signal of the vehicle is located, is determined as the area of interest; or a right area, where a direction indicated by a right turn signal of the vehicle is located, is determined as the area of interest.

In some embodiments, determining the area of interest around the vehicle based on the information related to driving of the vehicle includes at least one of: obtaining relative position information of the surrounding object of the vehicle to the vehicle based on the information of the surrounding object of the vehicle, and determining an area where the object falling into a monitoring area of the vehicle is located as the area of interest; or obtaining the relative position information of the surrounding object of the vehicle to the vehicle based on the information of the surrounding object of the vehicle, determining that the object does not fall into the monitoring area of the vehicle, but has a distance to the monitoring area within a preset range, and determining, in a case where a relative moving speed value of the vehicle to the object exceeds a preset speed value, a monitoring area closest to the object as the area of interest.

In some embodiments, obtaining the relative position information of the surrounding object of the vehicle to the vehicle based on the information of the surrounding object of the vehicle includes: determining, based on position information of the surrounding object of the vehicle and position information of at least one monitoring area of the vehicle, that the relative position information of the surrounding object of the vehicle to the vehicle as at least one of: the surrounding object of the vehicle falls within the at least one monitoring area of the vehicle; the surrounding object of the vehicle does not fall within any monitoring area of the vehicle, but has a distance to the at least one monitoring area of the vehicle within the preset range; or the surrounding object of the vehicle does not fall within any monitoring area of the vehicle, and has a distance to any monitoring area of the vehicle beyond the preset range.

The surrounding object of the vehicle may be another vehicle (a car, an electric bicycle, a motorcycle, a bicycle, a boat, or the like), a pedestrian, or the like.

In some embodiments, obtaining the information indicating that the driving direction of the vehicle is changing or is about to change includes: obtaining information indicating that the vehicle is reversing or is about to reverse; obtaining information indicating that the vehicle is making a turn or is about to make a turn; and obtaining information indicating that the vehicle is merging to a lane or is about to merge to a lane.

In operation 103, an image capturing device capable of capturing an image of the area of interest is determined.

A format of the image captured by the image capturing device is not limited, which may include, but is not limited to, a video image in a format including, but not limited to, color, black and white, infrared and radar images, and the like.

In some embodiments, determining the image capturing device capable of capturing the image of the area of interest includes: determining a relative orientation of the area of interest to the vehicle; and determining an image capturing device for capturing an image at the relative orientation as an image capturing device with an image capturing range covering the area of interest.

For example, the relative orientation of the area of interest to the vehicle may be front left, left, front right, right, rear left, rear, rear right, front, and the like of the vehicle.

In operation 104, the display device is controlled to display the image captured by the determined image capturing device.

The image captured by the determined image capturing device may be displayed in various manners, for example, by turning off display of images captured by other image capturing devices, and displaying only the image captured by the determined image capturing device; by flashing and displaying the image captured by the determined image capturing device; by adding a frame to display the image captured by the determined image capturing device; or by displaying corresponding characters in an overlapping manner while displaying the image captured by the determined image capturing device, and the like.

The display device is mounted on the vehicle at a position convenient for the driver to view, for example, at a position in front of the driver, or at a position of a conventional rearview mirror, and the like.

In some embodiments, controlling the display device to display the image captured by the determined image capturing device includes at least one of: closing a currently displayed image and displaying the image captured by the determined image capturing device; or displaying the currently displayed image and the image captured by the determined image capturing device in a partitioned manner. When more than one image capturing devices are determined, an image captured by each of the determined image capturing devices is displayed in a partitioned manner; or when more than one image capturing devices are determined, images captured by some of the determined image capturing devices are displayed based on priorities of the determined image capturing devices.

In some embodiments, controlling the display device to display the image captured by the determined image capturing device includes: controlling the display device to display the image captured by the determined image capturing device in a highlighted manner; obtaining and determining an area where a dangerous situation is most likely to occur or an area with a dangerous situation having the highest priority from the area of interest, and controlling the display device to display an image of the area in the highlighted manner; or selecting a locally significant image block from a whole image captured by the determined image capturing device, and controlling the display device to display the locally significant image block.

In some embodiments, the display control method further includes: displaying alarm information, when determining that currently obtained information related to driving of the vehicle meets a predetermined dangerous condition.

In some embodiments, displaying the alarm information when determining that the information related to driving of the vehicle meets the predetermined dangerous condition includes at least one of: displaying the alarm information, when determining that a case where a physical distance between the vehicle and the surrounding object is smaller than a preset threshold meets the predetermined dangerous condition based on the information related to driving of the vehicle; displaying the alarm information, when determining that a case where another vehicle or a pedestrian appears in a driver blind area (i.e., the area which cannot be observed by the driver through sights, including the areas which cannot be observed through the middle rearview mirror and the side rearview mirror) around the vehicle meets the predetermined dangerous condition based on the information related to driving of the vehicle; displaying the alarm information, when determining that a case where the real-time physical speed of the vehicle exceeds the preset threshold meets the predetermined dangerous condition based on the information related to driving of the vehicle; or displaying the alarm information, when determining that a case where the vehicle is approaching the surrounding object at a relative speed beyond a threshold meets the predetermined dangerous condition based on the information related to driving of the vehicle.

It should be noted that an acoustic alarm may be given when determining that the currently obtained information related to driving of the vehicle meets the predetermined dangerous condition. Besides the acoustic alarm, manual driving can be forcibly switched to automatic driving, and a steering wheel is taken over for automatic driving to avoid a dangerous behavior.

In the embodiments of the present disclosure, by obtaining the information related to driving of the vehicle, determining, based on the information related to driving of the vehicle, the area of interest around the vehicle, determining the image capturing device capable of capturing the image of the area of interest, and controlling the display device to display the image captured by the determined image capturing device, the image captured by the image capturing device needing to be viewed can be selected according to the information related to driving of the vehicle to meet the viewing requirements of the user during driving, intelligence and flexibility of monitoring and displaying can be improved, and possibility for safe driving of the vehicle is provided.

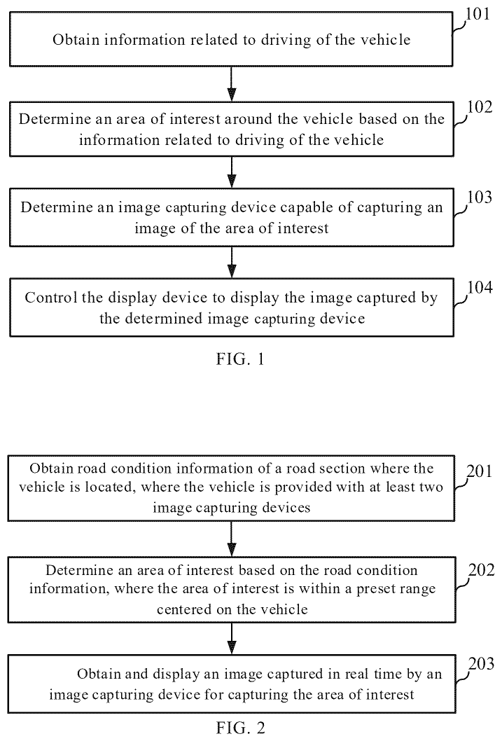

FIG. 2 is a schematic flowchart of a display control method for a vehicle equipped with a plurality of image capturing devices according to an embodiment of the present disclosure. As shown in FIG. 2, a display control method for the vehicle equipped with the plurality of image capturing devices includes the following operations 201 to 203.

In operation 201, road condition information of a road section where the vehicle is located is obtained, where the vehicle is provided with at least two image capturing devices.

In some embodiments, the road condition information of the road section where the vehicle is located may be obtained in various manners. For example, the road condition information is detected by a radar mounted on the vehicle, or is obtained by interaction with the outside (another nearby vehicle, and the like) through a V2X module mounted on the vehicle. It should be noted that the obtaining methods are only exemplary here, and other methods for obtaining the road condition information are also included herein. For example, the road condition information may be obtained through an image captured by an image capturing device in an on state, or through the Internet of Things.

In some embodiments, the vehicle is provided with at least two of the following image capturing devices: a front image capturing device, a rear image capturing device, a left image capturing device (which may include at least one of a front left image capturing device and a rear left image capturing device), and a right image capturing device (which may include at least one of a front right image capturing device and a rear right image capturing device).

In some embodiments, obtaining the road condition information of the road section where the vehicle is located includes: obtaining road condition information of a road section matched with a current driving behavior. For example, when a driving behavior of merging is monitored, road condition information of a road section on a merging direction side is obtained for the vehicle; or, when a driving behavior of turning is detected, road condition information of a road section on a turning direction side is obtained for the vehicle.

In operation 202, an area of interest is determined based on the road condition information, where the area of interest is within a preset range centered on the vehicle.

In some embodiments, the road condition information includes relative position information of the vehicle to a surrounding object. Correspondingly, determining the area of interest based on the road condition information includes: determining the area of interest based on the relative position information and position information of at least one monitoring area of the vehicle.

In some embodiments, determining the area of interest based on the relative position information and the position information of the at least one monitoring area of the vehicle includes: determining a positional relation between the surrounding object and the at least one monitoring area based on the relative position information and the position information of the at least one monitoring area of the vehicle, and selecting the area of interest from the at least one monitoring area according to the positional relation.

In some embodiments, determining the positional relation between the surrounding object and the at least one monitoring area based on the relative position information and the position information of at least one monitoring area of the vehicle includes: performing the following processing for any monitoring area: determining the positional relation between the surrounding object and the monitoring area as “belong to”, when it is determined that the surrounding object falls within a range of the monitoring area based on the relative position information and the position information of the monitoring area; determining the positional relation between the surrounding object and the monitoring area as “close to”, when it is determined that the surrounding object does not fall within the range of the monitoring area and a distance between the surrounding object and the monitoring area is within a preset range based on the relative position information and the position information of the monitoring area; or determining the positional relation between the surrounding object and the monitoring area as “neither belonging nor close to”, when it is determined that the surrounding object does not fall within the range of the monitoring area and the distance between the surrounding object and the monitoring area is beyond the preset range based on the relative position information and the position information of the monitoring area.

Accordingly, selecting the area of interest from the at least one monitoring area according to the positional relation includes, but is not limited to the following two cases, and the area of interest may be obtained from any one of the following two cases, or selection results of the following two cases may be jointly taken as a final area of interest:

In case 1, a monitoring area with the positional relation of “belonging to” is selected from the at least one monitoring area as the area of interest.

In case 2, a monitoring area with the positional relation of “close to” is selected from the at least one monitoring area, the relative motion speed value of the surrounding object to the vehicle is obtained, and the selected monitoring area is determined as the area of interest when the relative motion speed value exceeds the preset speed value.

The surrounding object may include another vehicle (a car, an electric bicycle, a motorcycle, a bicycle, a boats, or the like), a pedestrian, or the like.

In operation 203, an image captured in real time by an image capturing device for capturing the area of interest is obtained and displayed.

A display screen used for displaying the image captured in real time by the image capturing device is mounted on the vehicle at a position convenient for the driver to view, for example, at a position in front of the driver, or at a position of a conventional rearview mirror, and the like.

In some embodiments, when at least two areas of interest are determined, at least two image capturing devices respectively corresponding to the at least two areas of interest are determined, and images captured in real time by the at least two image capturing devices are simultaneously displayed in different display areas of the display screen.

In some embodiments, while the image captured in real time by the image capturing device for capturing the area of interest is obtained and displayed, an acoustic alarm may be further given to prompt the driver of a danger in the area of interest. Besides the acoustic alarm, manual driving can be forcibly switched to automatic driving, and the steering wheel is taken over for automatic driving to avoid a dangerous behavior.

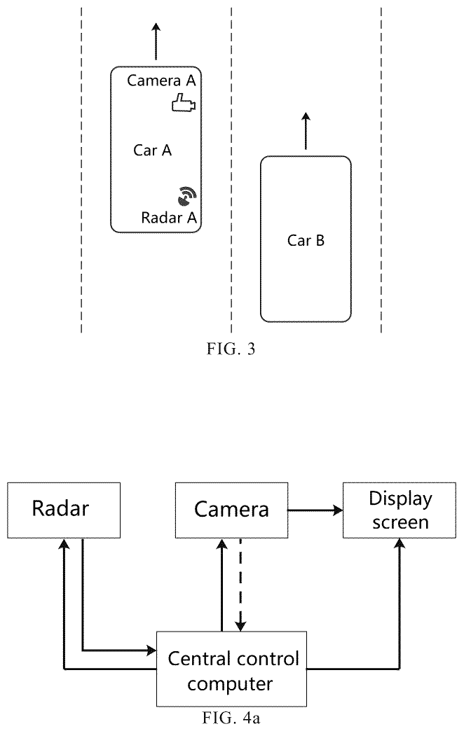

FIG. 3 is a schematic scenario diagram of detecting road condition information by an automotive radar according to an embodiment of the present disclosure. A process of intelligently selecting a camera image based on information detected by the automotive radar is as follows.

When a radar (radar A) on a car A detects that a car B is approaching from a rear right of the car A, a central control computer of the car A analyzes information detected by the radar A, intelligently starts a right camera (or a right blind area camera for imaging a blind area on the right side of the driver), i.e., a camera A, of the car A, and displays an image from the camera (the camera A) on a display screen in front of the driver. If desired, an appropriate acoustic alarm may be given to prompt the driver that there is an incoming car on the rear right.

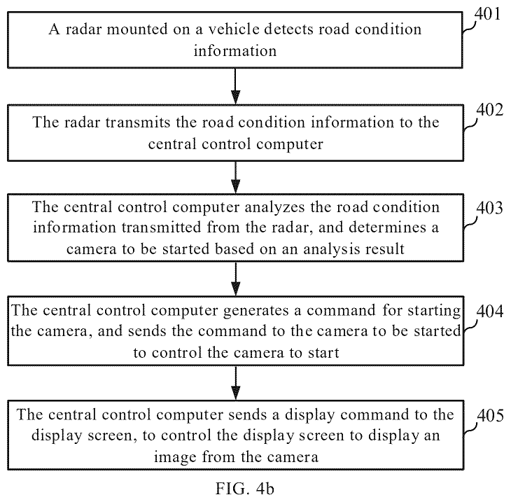

FIG. 4a is a schematic structural diagram of selecting a camera image using information detected by an automotive radar according to an embodiment of the present disclosure. As shown in FIG. 4a, a radar, a camera and a display screen are respectively connected to a central control computer, and each of which operates under control of the central control computer. The central control computer obtains and analyzes information detected by the radar, and then controls the camera to start for display through the display screen.

FIG. 4b is a schematic flowchart of intelligently selecting a camera image using information detected by an automotive radar according to an embodiment of the present disclosure, which includes the following operations 401 to 405.

In operation 401, a radar mounted on a car detects road condition information. For example, the road condition information indicates that there is an incoming car on a rear right of the present car.

In operation 402, the radar transmits the road condition information to the central control computer.

In operation 403, the central control computer analyzes the road condition information transmitted from the radar, and determines a camera to be started based on an analysis result.

In operation 404, the central control computer generates a command for starting the camera, and sends the command to the camera to be start to control the camera to start. This operation is optional, and may be omitted if the selected camera is already in an on state.

In operation 405, the central control computer sends a display command to the display screen, to control the display screen to display an image from the camera.

FIG. 5 is a schematic scenario diagram of obtaining road condition information by V2X according to an embodiment of the present disclosure. A process of intelligently selecting a camera image based on the road condition information obtained by V2X is as follows.

When a distance between the car A and the car B is less than a certain length (an effective communication distance of V2X), the car A and the car B start communication through V2X. The central control computer of the car A may analyze information obtained through V2X communication, to determine that a car (the car B) is approaching from the rear right of the car A. At this time, the central control computer of the car A may intelligently starts the right camera (or the right blind area camera for imaging the blind area on the right side of the driver), i.e., the camera A, of the car A, and displays the image from the camera (the camera A) on the display screen in front of the driver. If desired, the appropriate acoustic alarm may be given to prompt the driver that there is the incoming car on the rear right.

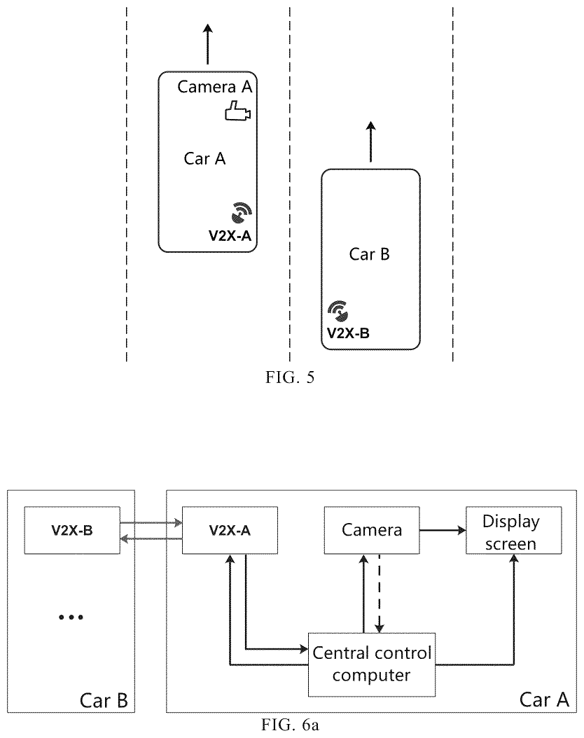

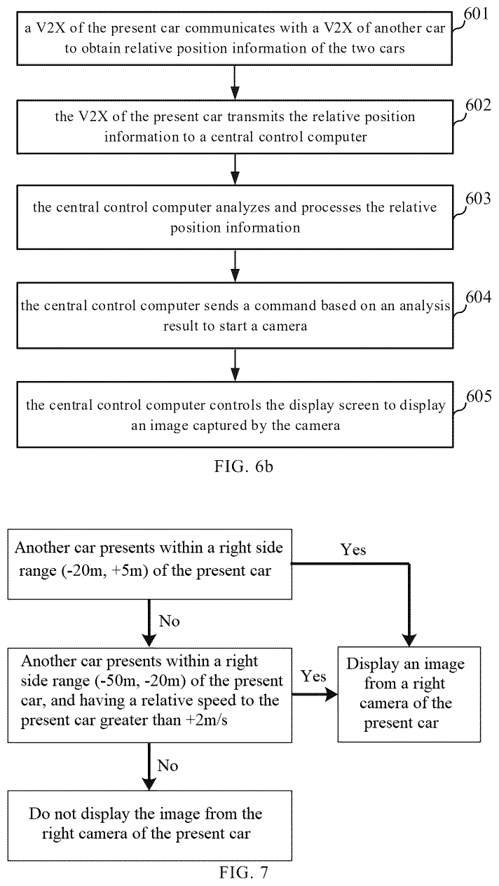

FIG. 6a is a schematic structural diagram of intelligently selecting a camera image using V2X information according to an embodiment of the present disclosure. As shown in FIG. 6a, in the car A, a V2X module (V2X-A), a camera, and a display screen are respectively connected to a central control computer, and each of which operates under control of the central control computer. The V2X-A on the car A performs information interaction with a V2X module (V2X-B) on the car B, the central control computer of the car A analyzes information interacted between the V2X-A and the V2X-B, and then controls the camera to start for display through the display screen.

FIG. 6b is a schematic flowchart of intelligently selecting a camera image using V2X information according to an embodiment of the present disclosure, which includes the following operations 601 to 605.

In operation 601, a V2X of the present car communicates with a V2X of another car to obtain relative position information of the two cars.

In operation 602, the V2X of the present car transmits the relative position information to a central control computer.

In operation 603, the central control computer analyzes and processes the relative position information.

In operation 604, the central control computer sends a command based on an analysis result to start a camera. This operation may be omitted if the camera is already in an on state.

In operation 605, the central control computer controls the display screen to display an image captured by the camera.

FIG. 7 is a schematic diagram of a control logic of intelligently selecting a camera image according to an embodiment of the present disclosure. As shown in FIG. 7, on-car sensors, such as an automotive radar, V2X, or the like, are used to detect presence of another car around the present car, and a relative distance and a relative speed of the other car to the present car. This embodiment is illustrated by taking a case where another car is present on a right side of the present car as an example, and a control logic for a case where another car is present on a left side of the present car is similar. If at least one other car is present within a right side range (−20 m, +5 m) of the present car (i.e., within 20 m on a rear right of the present car and within 5 m on a front right of the present car, including being parallel to the present car), an image from a right camera of the present car is displayed. If no other car is present within the above range, it is checked whether there is another car within a right side range (−50 m, −20 m) of the present car (i.e., within 20 m to 50 m on the rear right of the present car) and having a relative speed to the present car greater than +2 m/s (i.e., the other car is co-directional with the present car but is at least 2 m/s faster than the present car). If such a car is present, the image from the right camera of the present car is displayed. If such a car is not present, the image from the right camera of the present car is not displayed. It is worth noting that if it is determined that images from the right camera and a left camera are both to be displayed according to the above control flow, then the display screen may be divided into left and right halves to display the images from the left camera and the right camera, respectively.

In some embodiments, obtaining the road condition information of the road section where the vehicle is located includes: obtaining the road condition information of the road section matched with the current driving behavior. When the road condition information of the road section matched with the current driving behavior is obtained, an image from an image capturing device matched with the driving behavior may be directly displayed. For example, when the driving behavior of merging is monitored, the road condition information of the road section on the merging direction side is obtained for the vehicle; or, when the driving behavior of turning is detected, the road condition information of the road section on the turning direction side is obtained for the vehicle. When the driving behavior of merging is monitored, an image from a camera on the merging direction side is directly displayed. For example, if the vehicle is merging to the left lane, an image from a camera for capturing a left area of the vehicle is directly displayed; and if the vehicle is merging to the right lane, an image from a camera for capturing a right area of the vehicle is directly displayed. When the driving behavior of turning is monitored, an image from a camera on the turning direction side is directly displayed. For example, when the vehicle is turning to the left, the image from the camera for capturing the left area of the vehicle is directly displayed; and when the vehicle is turning to the right, the image from the camera for capturing the right area of the vehicle is directly displayed.

Compared to a conventional display control method in which an image from a front wide-angle camera of a vehicle is displayed by default, and an image from a rear camera of the vehicle may be switched for display during reversing, the display control method provided in the embodiments of the present disclosure can select a matched area of interest within a preset range centered on the vehicle based on the road condition information of the road section where the vehicle is located, and display an image from an image capturing device for the area of interest, so that intelligent selection and display of images are realized, the viewing requirements of the user during driving is met, intelligence and flexibility of displaying are improved, and possibility for safe driving of the vehicle is provided.

The display control method for the vehicle is provided by combining some new technologies emerging in the intelligentization and electronization trends of vehicles, such as an automotive radar, V2X and the like, with requirements of automobile intelligent control, intelligent display, and the like. The embodiments of the present disclosure can make full use of information obtained by each sensor of the vehicle, analyze and process the information through a processing device, such as a central control computer, on the vehicle, and intelligently turn on and off or switch displays of camera images, thereby greatly improving comfort, safety and driving experience of the driver, improving driving safety and further reducing an accident rate. For example, in case of some specific dangerous conditions, for example, when it is detected that the driver plans to merge or make a turn and there is another vehicle or a pedestrian in a blind area or on a side of the vehicle, the driver can be prompted to pay attention to a dangerous area in time by switching the displays of the camera images, and an alarm may be further given, thereby providing a guarantee for safe driving, improving driving experience of the driver, effectively avoiding some dangerous conditions in driving, and improving road safety.

The vehicle to which the display control method in the embodiments of the present disclosure is applied includes, but are not limited to, a family car, a bus, an engineering vehicle, a trucks, a motorcycle, and the like, and may be further applied to various types of ships. This is merely exemplary and does not exclude possibility of applications to other vehicles.

The division of operations of any of the above methods is merely for clarity, and in implementations, these operations may be combined into one operation, or a certain operation may be split into a plurality of operations, which both fall within the protection scope of the present disclosure as long as the same logical relationship is included. Any insignificant modification added or any insignificant design introduced to algorithms or processes without changing core designs of the algorithms or processes falls within the protection scope of the present disclosure.

An embodiment of the present disclosure further provides a display control apparatus for a vehicle having a display device, where specific implementations of the display control apparatus may refer to the related descriptions of the method embodiments, which are not repeated here. FIG. 8 is a schematic structural view of the display control apparatus. As shown in FIG. 8, the display control apparatus includes: an obtaining module 801, an area determination module 802, a device determination module 803, and a display module 804.

The obtaining module 801 is configured to obtain information related to driving of the vehicle.

The area determination module 802 is configured to determine an area of interest around the vehicle based on the information related to driving of the vehicle.

The device determination module 803 is configured to determine an image capturing device capable of capturing an image of the area of interest.

The display module 804 is configured to control the display device to display the image captured by the determined image capturing device.

Functions of or modules included in the apparatus provided in the embodiments of the present disclosure may be used to execute the method described in the method embodiments, and for the specific implementations and technical effects, reference may be made to the descriptions of the above method embodiments, and for brevity, details are not repeated here.

It should be noted that all modules referred to in the present implementation are logic modules, and in practical applications, one logic unit may be one physical unit, or a part of one physical unit, or may be implemented by a combination of multiple physical units. In addition, to highlight innovative parts of the present disclosure, units which are not so closely related to solving the technical problem proposed by the present disclosure are not introduced in the implementation, but this does not indicate that no other unit is present in the implementation.

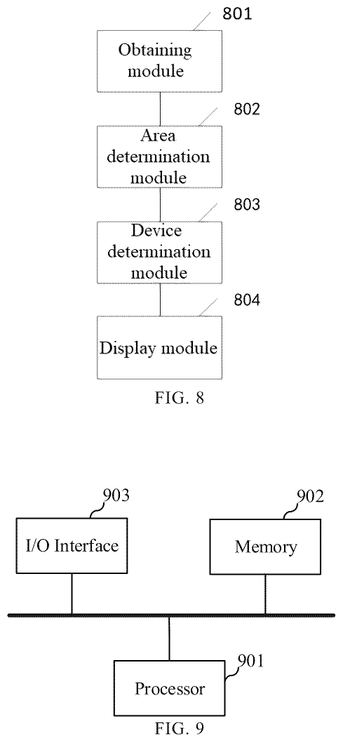

FIG. 9 is a schematic structural diagram of an electronic device according to an embodiment of the present disclosure. Referring to FIG. 9, an electronic device according to an embodiment of the present disclosure includes: at least one processor 901, a memory 902, and at least one I/O interface 903.

The memory 902 has at least one program stored thereon which, when executed by the at least one processor 901, causes the at least one processor 901 to implement the display control method described above.

The at least one I/O interface 903 is connected between the at least one processor 901 and the memory 902, and is configured to enable information interaction between the at least one processor 901 and the memory 902.

The at least one processor 901 is a device with a data processing capability, including but not limited to a central processing unit (CPU), or the like. The memory 902 is a device with a data storage capability, including but not limited to, a random access memory (RAM, more specifically SDRAM, DDR, etc.), a read-only memory (ROM), an electrically erasable programmable read-only memory (EEPROM) or a flash memory (FLASH). The at least one I/O interface (read/write interface) 903 is connected between the processor 901 and the memory 902 to enable information interaction between the at least one processor 901 and the memory 902, and includes, but is not limited to, a data bus or the like.

In some embodiments, the at least one processor 901, the memory 902, and at least one I/O interface 903 are connected to each other via a bus, and then further connected to other components of the electronic device.

The present embodiment further provides a computer-readable medium storing a computer program thereon which, when executed by a processor, causes the method provided in the embodiment to be implemented. To avoid repetition, specific operations of the method are not described in detail here.

Those of ordinary skill in the art will appreciate that all or some operations of the method described above, functional modules/units in system and apparatus may be implemented as software, firmware, hardware, and suitable combinations thereof. In a hardware implementation, division of the functional modules/units mentioned in the above description does not necessarily correspond to division of physical components; for example, one physical component may have multiple functions, or one function or operation may be performed cooperatively by several physical components. Some or all physical components may be implemented as software executed by a processor, such as a CPU, a digital signal processor or microprocessor, or implemented as hardware, or implemented as an integrated circuit, such as an application specific integrated circuit. Such software may be distributed on a computer-readable medium which may include a computer storage medium (or non-transitory medium). As is well known to those of ordinary skill in the art, the term of the computer storage medium includes volatile and nonvolatile, removable and non-removable medium implemented in any method or technology for storing information, such as computer-readable instructions, data structures, program modules or other data. The computer storage medium includes, but is not limited to, an RAM, an ROM, an EEPROM, a flash or any other memory technology, a CD-ROM, a digital versatile disk (DVD) or any other optical disk storage, a magnetic cartridge, a magnetic tape, a magnetic disk storage or any other magnetic storage device, or may be any other medium used for storing desired information and accessible by a computer.

It should be noted that, as used herein, the term “comprise”, “include” or any variant thereof means to be non-exclusive so that a process, method, item or device including a series of elements includes not only said elements, but also other elements not explicitly listed, or inherent elements of such processes, methods, items or devices. In the absence of more limitations, an element defined by “comprising a/an/the . . . ” does not exclude existence of additional identical elements in the process, method, item or device including the element.

Those skilled in the art will appreciate that although some embodiments described herein include some but not other features included in other embodiments, combinations of features of different embodiments are meant to be within the scope of the embodiments and form different embodiments.

It will be appreciated that the above implementations are merely exemplary implementations for the purpose of illustrating the principle of the present disclosure, and the present disclosure is not limited thereto. Various modifications and improvements can be made by a person having ordinary skill in the art without departing from the spirit and essence of the disclosure. Accordingly, all of the modifications and improvements also fall within the protection scope of the present disclosure.

1. A display control method for a vehicle having a display device, comprises:
obtaining information related to driving of the vehicle;
determining an area of interest around the vehicle based on the information related to driving of the vehicle;
determining an image capturing device capable of capturing an image of the area of interest; and
controlling the display device to display the image captured by the determined image capturing device.

2. The display control method for the vehicle according to claim 1, wherein obtaining the information related to driving of the vehicle comprises at least one of:
obtaining information of a surrounding object of the vehicle;
obtaining driving operation information of the vehicle; or
obtaining driving data information of the vehicle.

3. The display control method for the vehicle according to claim 2, wherein determining the area of interest around the vehicle based on the information related to driving of the vehicle comprises at least one of:
determining an area in which there is an object having a distance to the vehicle smaller than a preset threshold as the area of interest based on the information of the surrounding object of the vehicle;
determining an area pointed by a driving direction or a driving direction to be switched of the vehicle as the area of interest based on the driving operation information of the vehicle;
determining a real-time driving blind area of the vehicle as the area of interest based on the driving data information of the vehicle;
determining an area pointed by a driving direction when a real-time physical speed of the vehicle exceeds a preset threshold as the area of interest based on the driving data information of the vehicle; or
determining an area in which there is an object approaching the vehicle at a relative speed beyond a threshold as the area of interest based on the information of the surrounding object of the vehicle.

4. The display control method for the vehicle according to claim 1, wherein determining the image capturing device capable of capturing the image of the area of interest comprises:
determining a relative orientation of the area of interest to the vehicle; and
determining an image capturing device for capturing an image at the relative orientation as an image capturing device with an image capture range covering the area of interest.

5. The display control method for the vehicle according to claim 1, wherein controlling the display device to display the image captured by the determined image capturing device comprises at least one of:
closing a currently displayed image and displaying the image captured by the determined image capturing device;
displaying the currently displayed image and the image captured by the determined image capturing device in a partitioned manner;
when more than one image capture devices are determined, displaying an image captured by each of the determined image capturing devices in a partitioned manner; or
when more than one image capture devices are determined, displaying images captured by some of the determined image capturing devices based on priorities of the determined image capturing devices.

6. The display control method for the vehicle according to claim 1, wherein controlling the display device to display the image captured by the determined image capturing device comprises:
controlling the display device to display the image captured by the determined image capturing device in a highlighted manner;
obtaining and determining an area where a dangerous situation is most likely to occur or an area with a dangerous situation having the highest priority from the area of interest, and controlling the display device to display an image of the area in a highlighted manner; or
selecting a locally significant image block from a whole image captured by the determined image capturing device, and controlling the display device to display the locally significant image block.

7. The display control method for the vehicle according to claim 1, further comprising:
displaying alarm information, when determining that currently obtained information related to driving of the vehicle meets a predetermined dangerous condition.

8. The display control method for the vehicle according to claim 2, wherein obtaining the information of the surrounding object of the vehicle comprises at least one of:
obtaining the information of the surrounding object of the vehicle by a radar device;
obtaining information of another vehicle around the vehicle through vehicle to X (V2X) communication with the other vehicle; or
obtaining the information of the surrounding object of the vehicle by an image capturing device.

9. The display control method for the vehicle according to claim 2, wherein obtaining the driving operation information of the vehicle comprises:
obtaining information indicating that a driving direction of the vehicle is changing or is about to change.

10. The display control method for the vehicle according to claim 9, wherein obtaining the information indicating that the driving direction of the vehicle is about to change comprises:
obtaining turn signal information of the vehicle.

11. The display control method for the vehicle according to claim 9, wherein obtaining the information indicating that the driving direction of the vehicle is changing or is about to change comprises:
obtaining information indicating that the vehicle is reversing or is about to reverse;
obtaining information indicating that the vehicle is making a turn or is about to make a turn; and
obtaining information indicating that the vehicle is merging to a lane or is about to merge to a lane.

12. The display control method for the vehicle according to claim 3, wherein determining the area pointed by the driving direction or the driving direction to be switched of the vehicle as the area of interest based on the driving operation information of the vehicle comprises at least one of:
determining an area pointed by a merging direction of the vehicle as the area of interest based on the driving operation information of the vehicle; or
determining an area where a direction indicated by a turn signal of the vehicle is located as the area of interest based on the driving operation information of the vehicle.

13. The display control method for a vehicle according to claim 2, wherein determining the area of interest around the vehicle based on the information related to driving of the vehicle comprises at least one of:
obtaining relative position information of the surrounding object of the vehicle to the vehicle based on the information of the surrounding object of the vehicle, and determining an area where the object falling into a monitoring area of the vehicle is located as the area of interest; or
obtaining the relative position information of the surrounding object of the vehicle to the vehicle based on the information of the surrounding object of the vehicle, determining that the object does not fall into the monitoring area of the vehicle, but has a distance to the monitoring area within a preset range, and determining, in a case where a relative motion speed value of the vehicle to the object exceeds a preset speed value, a monitoring area closest to the object as the area of interest.

14. The display control method for the vehicle according to claim 13, wherein obtaining the relative position information of the surrounding object of the vehicle to the vehicle based on the information of the surrounding objects of the vehicle comprises:
determining, based on position information of the surrounding object of the vehicle and position information of at least one monitoring area of the vehicle, that the relative position information of the surrounding object of the vehicle to the vehicle as at least one of:
the surrounding object of the vehicle falls within the at least one monitoring area of the vehicle;
the surrounding object of the vehicle does not fall within any monitoring area of the vehicle, but has a distance to the at least one monitoring area of the vehicle within the preset range; or
the surrounding object of the vehicle does not fall within any monitoring area of the vehicle, and has a distance to any monitoring area of the vehicle beyond the preset range.

15. (canceled)

16. An electronic device, comprising:
at least one processor; and
a memory having one or more programs stored thereon which, when executed by the one or more processors, cause the one or more processors to:
obtain information related to driving of a vehicle;
determine an area of interest around the vehicle based on the information related to driving of the vehicle;
determine an image capturing device capable of capturing an image of the area of interest; and
control a display device to display the image captured by the determined image capturing device; and
at least one I/O interface connected between the at least one processor and the memory and configured to enable information interaction between the at least one processor and the memory.

17. A non-transitory computer-readable medium storing a computer program thereon which, when executed by a processor, causes the processor to:
obtain information related to driving of a vehicle;
determine an area of interest around the vehicle based on the information related to driving of the vehicle;
determine an image capturing device capable of capturing an image of the area of interest; and
control a display device to display the image captured by the determined image capturing device.
